(19) United States
(12) Patent Application Publication
(10) Pub. No.: US 2014/0080327 A1
(43) Pub. Date: Mar. 20, 2014

(54) SHIELDING SOCKET WITH A SHIELDING PLATE EXTENDING OUTSIDE FROM AN INSULATIVE HOUSING

(71) Applicant: Hon Hai Precision Industry Co., Ltd., New Taipei (TW)

(72) Inventors: TZU-YAO HWANG, New Taipei (TW); YEN-CHIH CHANG, New Taipei (TW)

(73) Assignee: Hon Hai Precision Industry Co., Ltd., New Taipei (TW)

(21) Appl. No.: 14/028,561

(22) Filed: Sep. 17, 2013

(30) Foreign Application Priority Data
Sep. 17, 2012 (TW) 101217893

(51) Int. Cl. H01R 13/648

(52) U.S. Cl. CPC H01R 13/648
USPC 439/65

(57) ABSTRACT

An electrical connector electrically connecting a chip module to a printed circuit board includes an insulative housing having a matching surface, a mounting surface and a receiving slot penetrated from the matching surface to the mounting surface, a number of terminals received in the receiving slot and a number of shielding plates received in the receiving slot; the shielding plate includes a body portion, a supporting portion bending outwardly from one side of the body portion and a contact portion extending outwardly from another side of the body portion, the contact portion includes a main body, a spring beam extending upwardly from the main body and a clip extending downwardly from the main body, the spring beam extending upwardly beyond the matching surface and the clip extending downwardly beyond the mounting surface.

### BACKGROUND OF THE INVENTION

1. Field of the Invention

The present invention relates to an electrical connector, and more particularly to an electrical connector having a shielding plate electrically connecting an Integrated Circuit package and a printed circuit board.

2. Description of the Prior Art

An electrical connector electrically connecting a chip module to a printed circuit board is described in Tai Wan Patent No. 419,248, issued to CHANG on Dec. 21, 2011. The electrical connector includes a socket body with a plurality of terminals secured therein. The socket body has a top surface, a low surface opposite to the top surface and a number of grooves penetrate from the top surface to the low surface. Each of the grooves includes a first groove and a second groove. The contact portions secured in the first grooves respectively. The electrical connector further includes a metal shielding plate assembled in the second groove. The terminal includes a base portion, an upper spring beam extending upwardly from the base portion, a lower spring beam extending downwardly from the base portion and a retention portion bending outwardly from a side of the base portion. The upper spring beam has a contacting portion bending upwardly and the lower spring beam has a soldering portion bending downwardly. The base portion, the retention portion, the upper spring beam and the lower spring beam received in the first groove. Due to the shielding plate is neither contacts with the chip module and nor the printed circuit board. The contacting portion and the soldering portion exposed at the exterior of the insulative housing that the shielding plate can not shield the whole terminal, so, it affects the quality of the signal transmission.

Therefore, it is needed to find a new electrical socket to overcome the problems mentioned above.

### SUMMARY OF THE INVENTION

Accordingly, an object of the present invention is to provide an electrical connector getting better shielding result.

In order to achieve the object set forth, an electrical connector electrically connecting a chip module to a printed circuit board comprises an insulative housing having a matching surface, a mounting surface and a receiving slot penetrated from the matching surface to the mounting surface, a plurality of terminals received in the receiving slot and a plurality of shielding plates received in the receiving slot; the shielding plate comprises a body portion, a supporting portion bending outwardly from one side of the body portion and a contact portion extending outwardly from the other side of the body portion, the contact portion comprises a main body, a spring beam extending upwardly from the main body and a clip extending downwardly from the main body, the spring beam extending upwardly beyond the matching surface and the clip extending downwardly beyond the mounting surface.

### BRIEF DESCRIPTION OF THE DRAWINGS

FIG. 1 is a perspective view of an electrical connector in accordance with a preferred embodiment of the present invention, and showing a sketch map of the electrical connector;

FIG. 2 is another perspective view of the electrical connector as shown in FIG. 1, and showing a mounting surface of the electrical connector;

FIG. 3 is an exploded view of the electrical connector shown in FIG. 1;

FIG. 4 is a perspective view of the insulative housing as shown in FIG. 3, and showing a matching surface of the insulative housing;

FIG. 5 is another perspective view of the insulative housing as shown in FIG. 3, and showing a mounting surface of the insulative housing;

FIG. 6 is a perspective view of the electrical connector electrically connecting the upper pad of the chip module to the lower soldering ball of the printed circuit board as shown in FIG. 1; and

FIG. 7 is another perspective view of the electrical connector electrically connecting the upper pad of the chip module to the lower soldering ball of the printed circuit board as shown in FIG. 1.

### DESCRIPTION OF PREFERRED EMBODIMENT

Reference will now be made to the drawings to describe the present invention in detail.

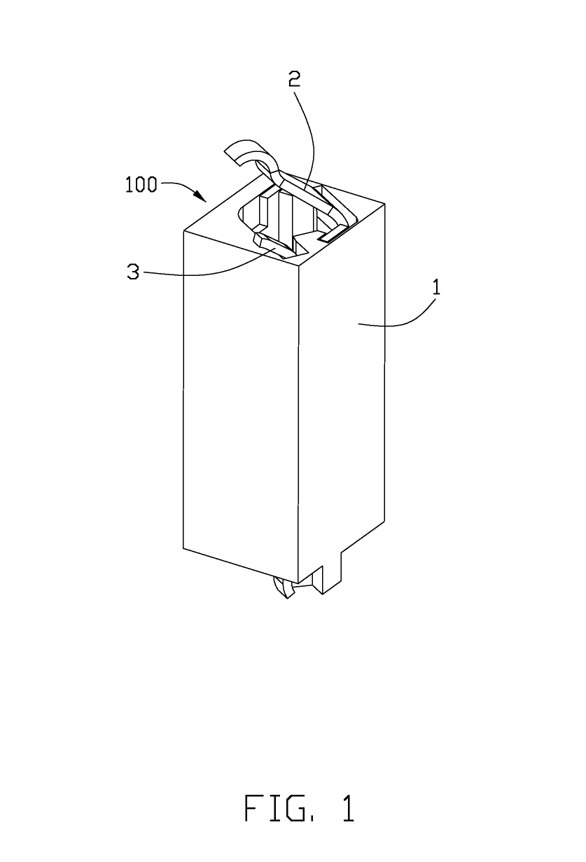

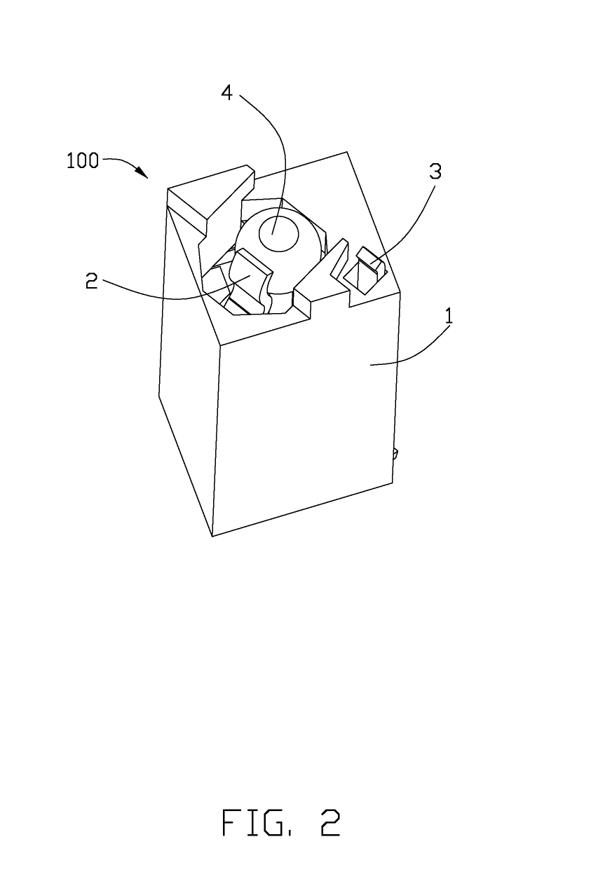

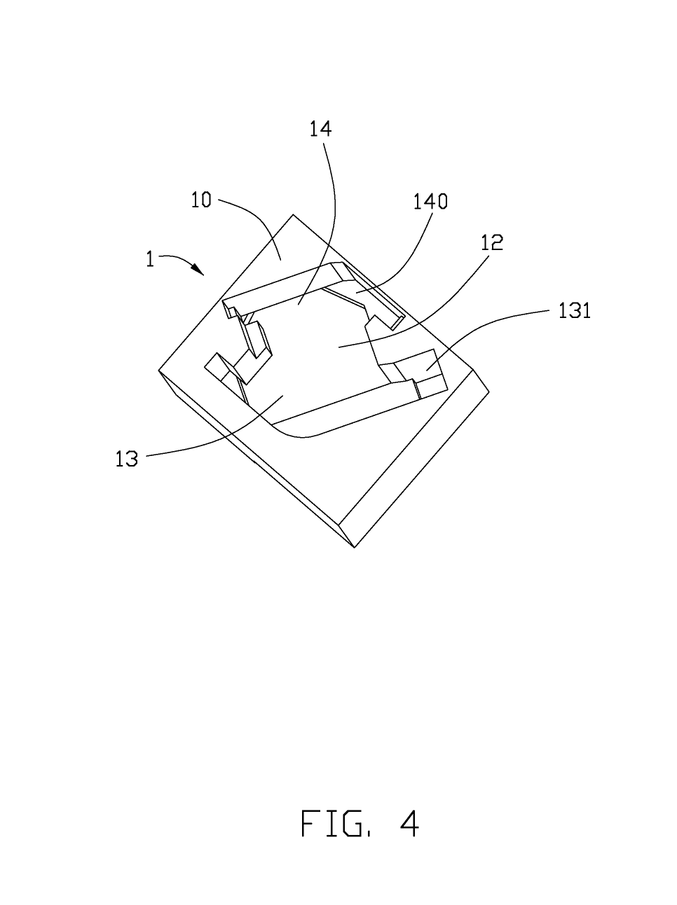

Referring to FIGS. 1-7, an electrical connector 100 according to the present invention is used to electrically connecting a chip module (not show) to a printed circuit board (not show). The electrical connector 100 comprises an insulative housing 1, a plurality of terminals 2 received therein, a plurality of shielding plates 3 received therein and a plurality of soldering balls 4 soldering the terminals 2 to the printed circuit board. The chip module comprises a bottom surface (not show) that has a plurality of upper pads 50 and a plurality of upper soldering balls 50 located around the upper pads 50. The printed circuit board comprises a top surface (not show) that has a plurality of lower pads (not show) and a plurality of lower soldering balls 61 located around the lower pads. The terminal 2 electrically connects the upper pad 50 of the chip module and the lower pad of the printed circuit board, the shielding plate 3 electrically connects the upper soldering ball 51 and the lower soldering ball 61.

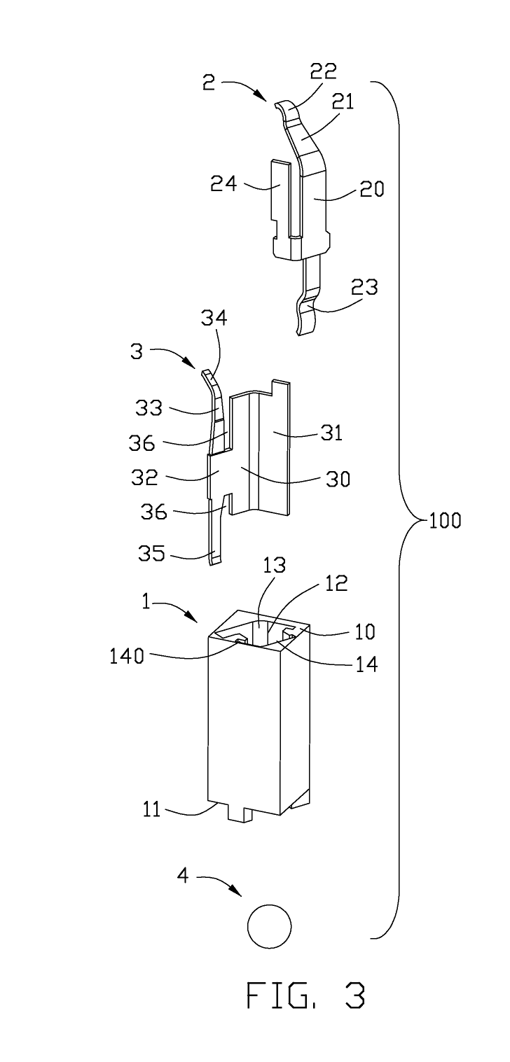

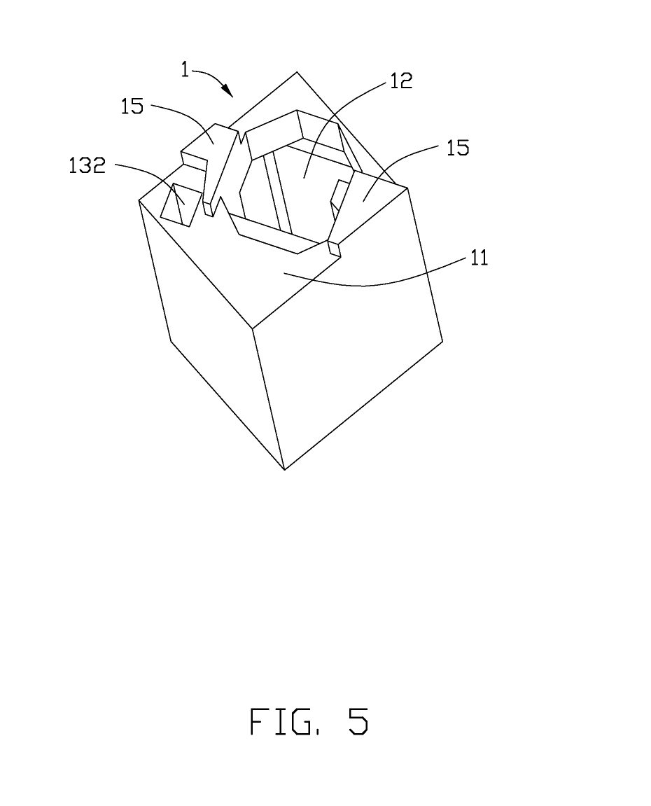

Referring to FIGS. 3 and 5, the insulative housing 1 is made up of insulation material and comprises a matching surface 10, a mounting surface 11 opposite to the matching surface 10 and a receiving slot 12 penetrated from the matching surface 10 to the mounting surface 11. The receiving slot 12 comprises a first receiving slot 13 for receiving the shielding plate 3 and a second receiving slot 14 for receiving the terminal 2 and communicated with each other. The second receiving slot 14 has a narrow slot 140 for fixing a retention portion 24 of the terminal 2. Both of the matching surface 10 and the mounting surface 11 are plated with a metal layer (not show). The insulative housing 1 has a tab 15 protruding from the mounting surface 11.

Referring to FIG. 3, each of the terminals 2 comprise a base 20, a first spring portion 21 bending upwardly from the base 20, a soldering portion 23 bending downwardly from the base 20 and said retention portion 24 bending outwardly from one side of the base 20. The first spring portion 21 has a first contacting portion 22 for electrically connecting with the upper pad 50 and the first contacting portion is configured with an arc shape. The soldering portion 23 is electrically connected with the lower pad by the solder ball 4. The retention portion 24 of the terminal 2 is received in the narrow slot 140 of the second receiving slot 14.

Each of the shielding plates 3 comprise a body portion 30, a supporting portion 31 bending outwardly from one side of the body portion 30 and a contact portion (not labeled) extending outwardly from another side of the body portion 30. The contact portion comprises a main body 32 and a contacting beam (not labeled) bending upwardly or downwardly from the main body 32. The contacting beam comprises a spring beam 33 extending upwardly from the main body 32 and a clip 35 extending downwardly from the main body 32. The spring beam 33 comprises a second contacting portion 34 connecting with the upper soldering ball 51 of the chip module, the clip 35 connects with lower soldering ball 61 of the printed circuit board. The main body 32 communicates with the body portion 30, both of the spring beam 33 and the body portion 30 have a slot 36, both of the clip 35 and the body portion 30 also have a slot 36.

Referring to FIGS. 1 to 5, after the terminals 2 and the shielding plates 3 assembled into the insulative housing 1, the terminal 2 is received in the second receiving slot 14 and the shielding plate 3 is received in the first receiving slot 13. The first contacting portion 22 of the terminal 2 extends upwardly beyond the matching surface 10 and the soldering portion 23 of the terminal 2 extends downwardly beyond the mounting surface 11 of the insulative housing 1. The second contacting portion 34 extends upwardly beyond the matching surface 10 of the shielding plate 3 and the clip 35 extends downwardly beyond the mounting surface 11 of the shielding plate 3. The first receiving slot 13 comprises a top recess 131 for receiving the spring beam 33 and a bottom recess 132 for receiving the clip 35.

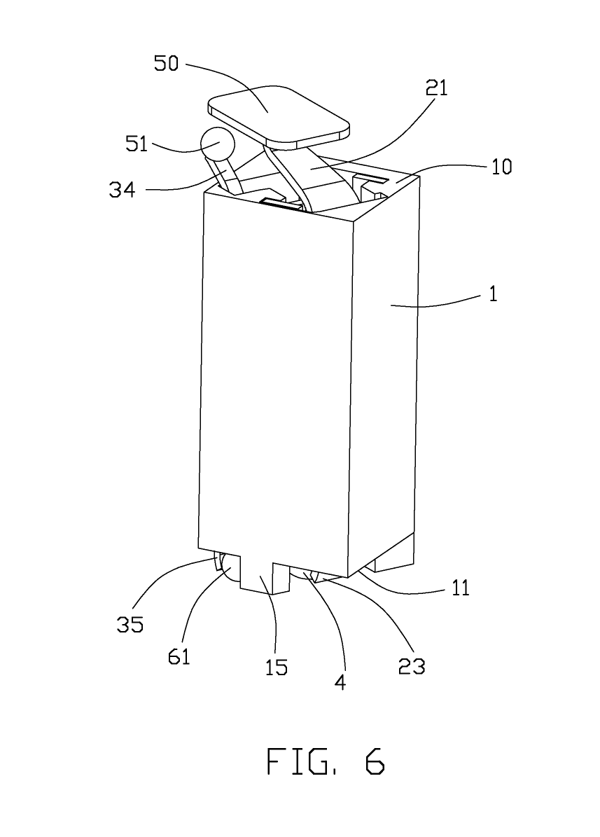

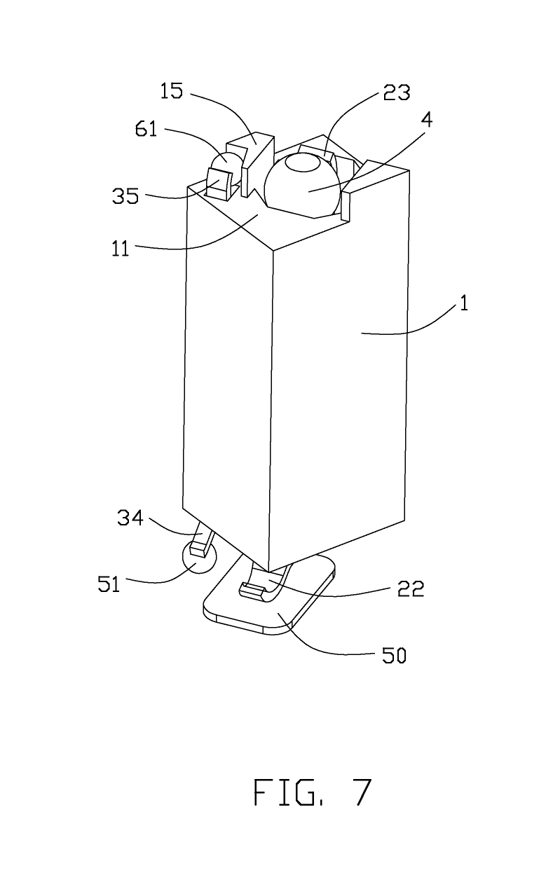

Referring to FIGS. 6 to 7, the first contacting portion 22 electrically connects with the upper pad 50 and the second contacting portion 34 electrically connects with the upper soldering ball 51, the solder ball 4 is fixed to the insulative housing 1 by clipping of the soldering portion 23 and the receiving slot 12, the lower soldering ball 61 is fixed to the insulative housing 1 by clipping of the clip 35 and the tab 15, and thus the clip 35 electrically connects with the printed circuit board.

The spring beam 33 extends upwardly beyond the matching surface 10 for electrically connecting the upper soldering ball 51 of the chip module, the clip 35 extends downwardly beyond the mounting surface 11 for electrically connecting the lower soldering ball 61 of the printed circuit board, and it not only can shield a portion of the terminal 2 that buried in the insulative housing 1, but also shield another portion of the terminal 2 that extending upwardly beyond the matching surface 10 and extending downwardly beyond the mounting surface 11. Thus, it can shield the whole terminal 2 and it can get better shielding effect, and it is easy to manufacture.

Both of the upper soldering ball 51 and the lower soldering ball 61 are materials used to soldering that comprise all of the metals.

Although the present invention has been described with reference to particular embodiments, it is not to be construed as being limited thereto. Various alterations and modifications can be made to the embodiments without in any way departing from the scope or spirit of the present invention as defined in the appended claims.

What is claimed is:

1. An electrical connector electrically connecting a chip module to a printed circuit board, and comprising:
an insulative housing comprising a matching surface, a mounting surface and a receiving slot penetrated from the matching surface to the mounting surface, the receiving slot comprises a first receiving slot and a second receiving slot;
a plurality of terminals received in the second receiving slot;
a plurality of shielding plates received in the first receiving slot; and
the shielding plate comprises a body portion, a supporting portion bending outwardly from one side of the body portion and a contact portion extending outwardly from another side of the body portion, the contact portion comprises a main body, a spring beam extending upwardly from the main body and a clip extending downwardly from the main body, the spring beam extending upwardly beyond the matching surface and the clip extending downwardly beyond the mounting surface.

2. The electrical connector as claimed in claim 1, wherein said spring beam is used to electrically connect with the chip module.

3. The electrical connector as claimed in claim 2, wherein said clip is used to electrically connect with the printed circuit board.

4. The electrical connector as claimed in claim 1, wherein said main body connects with the body portion, both of the spring beam and the body portion have a slot, both of the clip and the body portion also have a slot.

5. The electrical connector as claimed in claim 1, wherein said first receiving slot and the second receiving slot are communicated with each other, the first receiving slot has a narrow slot for fixing the terminal, the narrow slot is spaced with the second receiving slot.

6. The electrical connector as claimed in claim 1, wherein each of the terminals comprise a base, a first spring portion bending upwardly from the base, a soldering portion bending downwardly from the base and a retention portion bending outwardly from one side of the base.

7. The electrical connector as claimed in claim 1, wherein both of the matching surface and the mounting surface are plated with a metal layer.

8. The electrical connector as claimed in claim 7, wherein said insulative housing has a tab that cooperated with the clip protruding from the mounting surface.

9. An electrical connector electrically connecting a chip module to a printed circuit board, and comprising:
an insulative housing having a matching surface, a mounting surface and a receiving slot penetrating from the matching surface to the mounting surface, the receiving slot comprising a first receiving slot and a second receiving slot,
a plurality of terminals received in the second receiving slot;
a plurality of shielding plates received in the first receiving slot; and wherein
the shielding plate comprises a body portion and a contact portion extending outwardly from a side of the body portion, the contact portion comprises a main body, a spring beam extending upwardly from the main body for electrically connecting the chip module and a clip extending downwardly from the main body for electrically connecting the printed circuit board; wherein
the distance between an end of the spring beam and an end of the clip is larger than the distance between the matching surface and the mounting surface of the insulative housing in vertical direction.

10. The electrical connector as claimed in claim 9, wherein said spring beam is used to electrically connect the chip module and the clip is used to electrically connect the printed circuit board.

11. The electrical connector as claimed in claim 9, wherein said main body connects with the body portion, both of the spring beam and the body portion have a slot, both of the clip and the body portion also have a slot.

12. The electrical connector as claimed in claim 9, wherein said first receiving slot and the second receiving slot are communicated with each other, the first receiving slot has a narrow slot for fixing the terminal, the narrow slot is spaced with the second receiving slot.

13. The electrical connector as claimed in claim 9, wherein each of the terminals comprise a base, a first spring portion bending upwardly from the base, a soldering portion bending downwardly from the base and a retention portion bending outwardly from one side of the base.

14. The electrical connector as claimed in claim 9, wherein both of the matching surface and the mounting surface are plated with a metal layer.

15. The electrical connector as claimed in claim 14, wherein said insulative housing has a tab that cooperated with the clip protruding from the mounting surface.

16. The electrical connector as claimed in claim 9, wherein said spring beam extending upwardly beyond the matching surface and the clip extending downwardly beyond the mounting surface.

17. An electrical connector for use with a mother board and an electronic package, comprising:
an insulative housing defining opposite top and bottom faces in a vertical direction;
a plurality of receiving slots extending through the housing in said vertical direction, each of said receiving slots defining a first receiving slot on one side of the receiving slot and a second receiving slot on the other side in communication with said first receiving slot;
a plurality of terminals disposed in the corresponding second receiving slots, respectively, each of said terminals defining a resilient arm extending upwardly beyond the top face for electrical connection with the electronic package, and a solder tail associated with a solder ball for mounting to the mother board; and
a plurality of shielding plates disposed in the corresponding first receiving slots, respectively, each of said shielding plates defining a spring arm with means extending above the top face for electrical connection with the electronic package, and a tail with means extending below the bottom face for mounting to the mother board.

18. The electrical connector as claimed in claim 17, wherein the means of the spring arm is either a solder ball or a free end of the spring arm, and the means of the tail is either another solder ball or a free end of the tail.

19. The electrical connector as claimed in claim 17, wherein during assembling, the housing, the terminals and the shielding plates are configured to only first assemble the shielding plate into the corresponding first receiving slot downwardly from the top face first, and successively assemble corresponding terminal into the corresponding second receiving slot downwardly from the top face.

20. The electrical connector as claimed in claim 17, wherein the spring arm and the corresponding resilient arm are spaced from each other in the corresponding receiving slot
